(19) United States
(12) Patent Application Publication
(10) Pub. No.: US 2010/0005489 A1
(43) Pub. Date: Jan. 7, 2010

(54) TARGETED ADVERTISEMENT DELIVERY

(76) Inventor: Mark A. Losey, West Bloomfield, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 12/166,778

(22) Filed: Jul. 2, 2008

(51) Int. Cl. H04N 7/025; G06F 13/00; H04N 7/173

(52) U.S. Cl. 725/35; 725/38; 725/120

(57) ABSTRACT

A media delivery kiosk can be deployed at an establishment to deliver targeted advertisements to people waiting in the establishment. Through the analysis of demographic information, advertisements likely to appeal people waiting at a particular establishment may be delivered. The kiosk may also be interactive, which can aid in the gathering of additional demographic information about a specific user or the establishment. Advertising selection can be further user-tuned based on this demographic information and selected ads can be dynamically delivered in real-time.

### TECHNOLOGICAL FIELD

The illustrative embodiments generally relate to targeted advertisement delivery. More specifically, the illustrative embodiments relate to delivering predetermined categories of advertisements to receiving parties who are waiting at a location.

### BACKGROUND AND SUMMARY

Much of people's lives are spent waiting. Whether waiting for food at a restaurant or waiting to be seen at an appointment, people spend a fair amount of time waiting for desired events to occur. Often times, such as when waiting for a haircut, the owner of the establishment in which the waiting occurs provides magazines for people to read or a television for people to watch. Other times, such as when waiting for food at a restaurant, people read table-posted advertisements for deserts and/or restaurant specials.

The common thread among all of these situations is that there is a captive audience. Because the people waiting are not going anywhere, the establishment owners are free to deliver time-killing content in whatever manner they see fit. In many cases, the more interesting the content, the more quickly the time seems to pass for the customers.

While magazines, TV, and desert menus carry forms of advertisement, the also generally suffer from certain drawbacks. Magazine advertisements are targeted at readers. Since people in, for example, a salon may be reading the magazine for want of other material, the advertisements contained therein may not be reaching the desired audience. Those who watch television while waiting are typically watching whatever channel is set by the owner. Again, while the provided media advertisements may be viewer targeted, the viewers, at least in these situations, may be viewing that channel for a lack of options. Finally, as one more non-limiting example, desert menus, while interest occupying for a few moments, are often set aside once the reader has either selected a desert or decided against one. In all these instances, the time in which the owner has a captive audience could be spent delivering the best possible targeted media to that audience, while additionally making the waiting time pass more quickly.

According to one illustrative embodiment, a targeted media delivery system is provided for use by a customer. In this exemplary embodiment, the media delivery system includes a display screen and media feed. Based at least in part on the establishment in which the delivery system is located, the media feed is compiled to be somewhat user specific. The media feed can deliver user specific content and/or advertisements to the users, thus making the waiting time seem less onerous. Further, the media feed can be dynamically updated as various forms of demographic information become available or change.

In another illustrative embodiment, advertisements for the establishment take up a portion of the media feed. In this embodiment, an owner or manager determines what customer specific advertisements should be run on the device. For example, at lunch time, the media feed could include targeted advertisements for lunch specials. These advertisements can range from fixed media presentations, such as a menu, to pre-recorded commercials, such as those run on TV.

Since customers may not wish to constantly view a menu and/or establishment advertisements on the device, in another illustrative embodiment the remaining time is occupied by additional user-specific media delivery. For example, if the restaurant is a family restaurant, advertisements such as vacation advertisements, family activity advertisements, etc. may be run. In lieu of such advertisements, any customer targeted media may be provided.

In a further illustrative embodiment, the advertising system may include a link to, for example, a server. The server, and/or the advertising system itself, may be able to query certain locations on, for example, the internet, to discover demographic information. While the system may not know who specifically is utilizing it, it may be able to determine, for example, the local weather. Thus, in this illustrative embodiment, if the system “knows” it is raining or snowing, advertisements for sunny getaway vacations may be delivered to the users. Similarly, if the system “knows” it is a Friday, advertisements for weekend activities may be delivered.

In addition to a targeted media stream, a portion or all of the system's display may be used for interactive activities. For example, in one illustrative embodiment, the display is a touch-screen with which the user can interact. A variety of free games are provided to the user, and a portion of the screen is dedicated to targeted media delivery.

This embodiment can provide additional demographic information about a user. For example, if a game typically played by young children is being played, the advertisements can be for toys or vacations that a child might like. If a game more commonly played by adults is being played, again, the according targeted media can be delivered.

Through demographic cues such as, for example, the local weather, the type of establishment, and/or the type of user-interactive content being utilized, the illustrative embodiments can deliver a media feed that is more user specific than most magazine advertisements and TV ads delivered to waiting users. Additionally, since the recipients of the media are waiting for a particular event to occur, they are unlikely to depart the premises and thus a captive audience is obtained. By the inclusion of user interactive activities, additional demographic information about the audience is obtained, and the level of audience interest and participation may be raised. The resulting system may not only make the time seem to pass more quickly, benefiting both the owner and customer, but it may also deliver a highly effective targeted advertising stream.

### BRIEF DESCRIPTION OF THE DRAWINGS

Other objects, aspects and characteristics of the illustrative embodiments will become apparent from the following detailed description of exemplary embodiments, when read in view of the accompanying drawings, in which:

FIG. 1 shows an exemplary media delivery network;

FIG. 2 shows an exemplary block diagram of an exemplary advertising kiosk;

FIG. 3 shows an exemplary media delivery device;

FIGS. 4A and 4B show exemplary advertising displays;

FIG. 5 shows an exemplary advertisement display process;

FIG. 6 shows a second exemplary advertisement display process;

FIG. 7 shows a third exemplary advertisement display process;

FIGS. 8A and 8B show exemplary game and advertisement displays;

FIG. 9 shows an exemplary game and advertisement display process;

FIG. 10 shows an exemplary game control process; and

FIG. 11 shows an exemplary advertisement update process.

### DETAILED DESCRIPTION OF ILLUSTRATIVE EMBODIMENTS

The present invention is described herein in the context of particular exemplary illustrative embodiments. However, it will be recognized by those of ordinary skill in the art that modification, extensions and changes to the disclosed exemplary illustrative embodiments may be made without departing from the true scope and spirit of the instant invention. In short, the following descriptions are provided by way of example only, and the present invention is not limited to the particular illustrative embodiments disclosed herein.

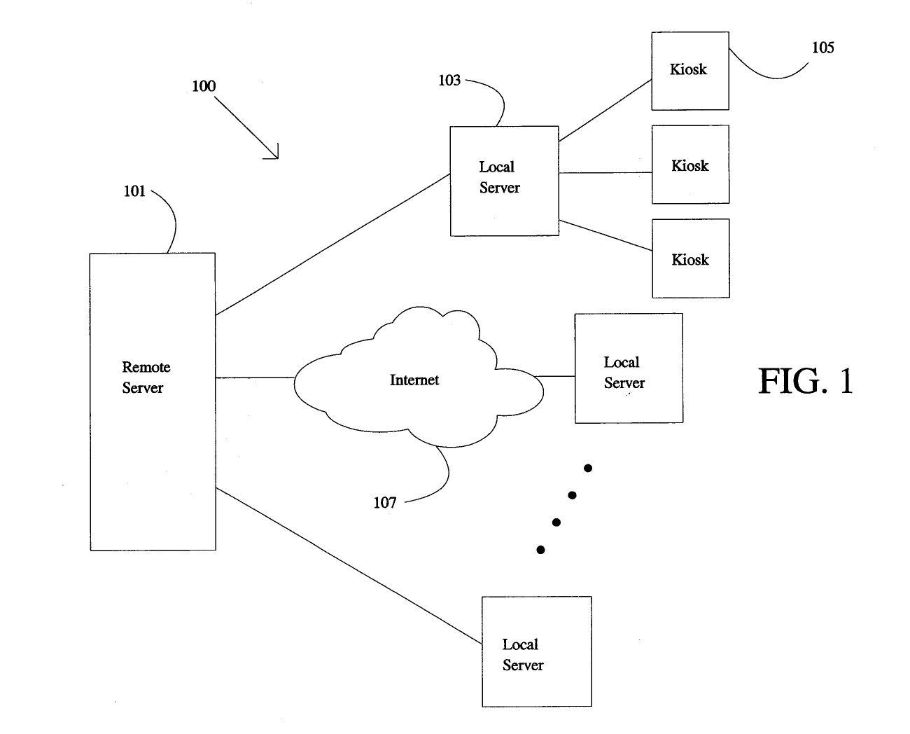

FIG. 1 shows an exemplary media delivery network 100. A remote server 101 may be provided. The remote server 101 may store a plurality of advertisements for delivery to particular targeted local servers 103 and, therethrough, delivery to advertising kiosks 105. The remote 101 server may also be provided with one or more programs to make decisions about particular advertisements to be delivered to particular kiosks 105 for delivery under particular conditions.

In one illustrative embodiment, one or more local servers 103 is located at an establishment wherein it is expected that a target audience will spend at least some portion of their time waiting. A non-exhaustive list includes restaurants, beauty parlors, doctor's offices, etc. In addition to the local sever 103, each location may provide one or more advertising kiosks 105 at a location where they can be viewed by, for example, waiting customers. These kiosks 105 may be wired or wirelessly in communication with the local server 103, receiving their content therefrom.

For example, in a restaurant, each table may have an advertising kiosk 105 located thereon. Customers can view targeted advertisements while they wait for their meal to be delivered. A doctor's office or beauty parlor may also have one or more kiosks 105 in a waiting area, where customers can pick them up and view/use them while they wait. It is also contemplated that the advertisements to be delivered to a customer waiting in a restaurant may be markedly different from those delivered to a customer waiting in a doctor's office. Alternatively, some or all of the advertisements may be the same, depending on what is deemed appropriate for the particular audience.

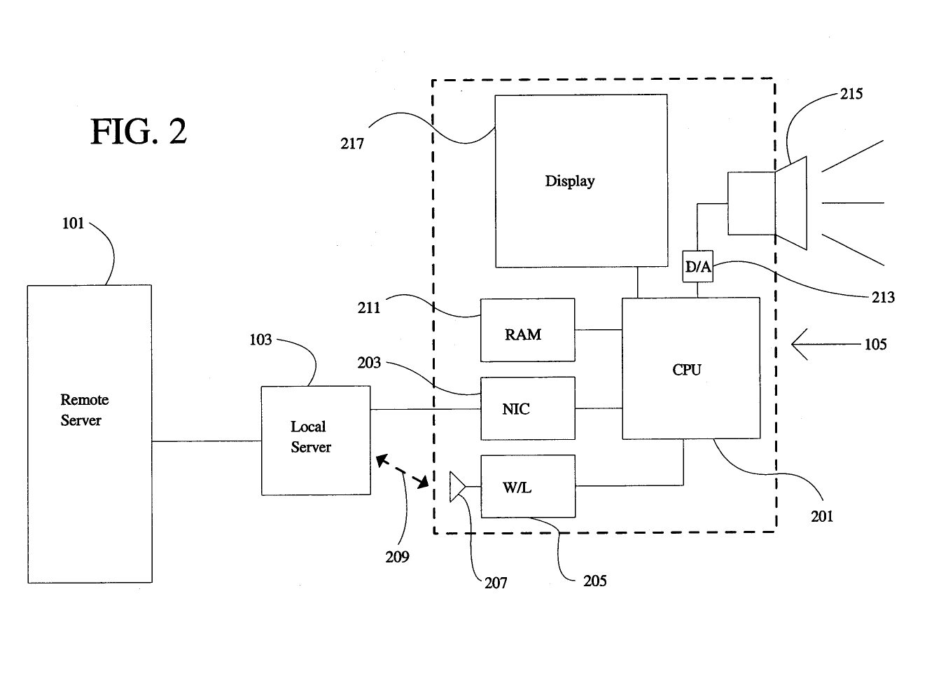

FIG. 2 shows an exemplary block diagram of an exemplary advertising kiosk 105. In one exemplary embodiment, after advertising has been delivered from the remote server 101 to the local server 103, it may be distributed to one or more advertising kiosks 105.

The kiosk 105 may be connected to the local server via a network interface card 203, a wireless connection 205 through an antenna 207, or any other suitable means for transfer of data. Signals 209 from the local server 103 pass to the processor 201 of the kiosk through these connections. The signals are distributed between a display 217 and a speaker 215 as necessary. It is also contemplated that the speaker may not be included if a silent display is desired. Alternatively, if only audio is desired, the display may be omitted. A digital to analog converter 213 converts signals passing from the processor to the speaker 215.

The kiosk is also provided with temporary and/or permanent storage. In this illustrative embodiment, only temporary storage 211 is provided, but a hard disk or other suitable storage could be added if desired.

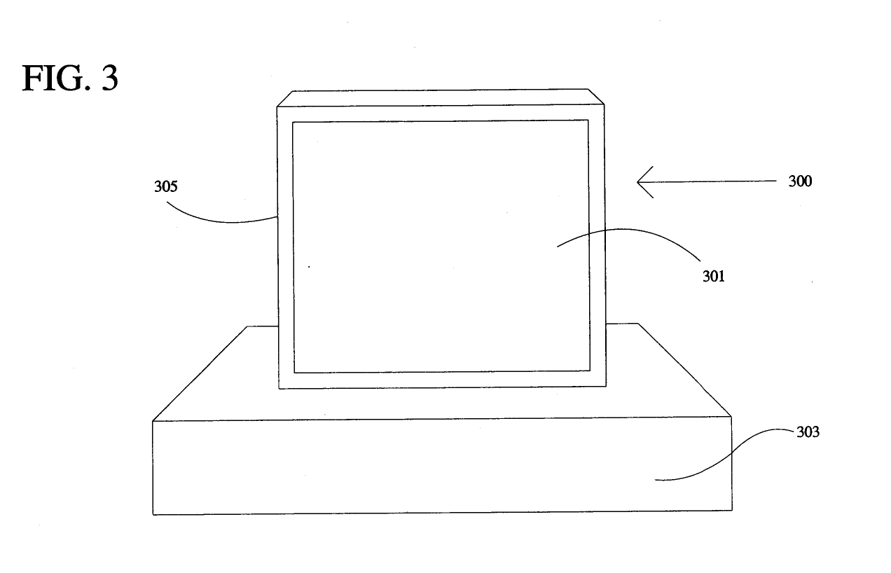

FIG. 3 shows an exemplary advertising kiosk 300. Although the kiosk could take any suitable form, one possible configuration is shown in FIG. 3. In this illustrative embodiment, the kiosk is small enough to be placed on a table and to be picked up and moved around by a user. This allows multiple users at the table to enjoy the kiosk. This exemplary kiosk includes an LCD display 301.

In this exemplary implementation, the LCD display is also a touch-sensitive display screen that can receive user input. Such a display allows the kiosk to provide the user with an interactive experience, and may help to encourage use. Additionally, such a display makes it possible to provide user games without the addition of external controls of some type. It is also possible to provide the user with a set of external controls, such as a joystick, buttons, keyboard, etc., or simply to provide a non-interactive display.

The display is framed by a protective frame 305. In certain environments, it may be further desirable to make both the frame and/or display water-proof, as there is the possibility that things might be spilled on the display while the display is in use. For example, children playing games at a restaurant may accidentally spill a drink on the display or elsewhere on the kiosk.

Finally, the base 303 of the kiosk contains the additional components, if any, needed for kiosk operation. Although this illustrative embodiment shows these components included in a base, they could be located in any suitable location. Further, it may be possible to integrate the display and components into a device of reduced size. Shown is only one of a myriad of possible configurations for the advertising kiosk.

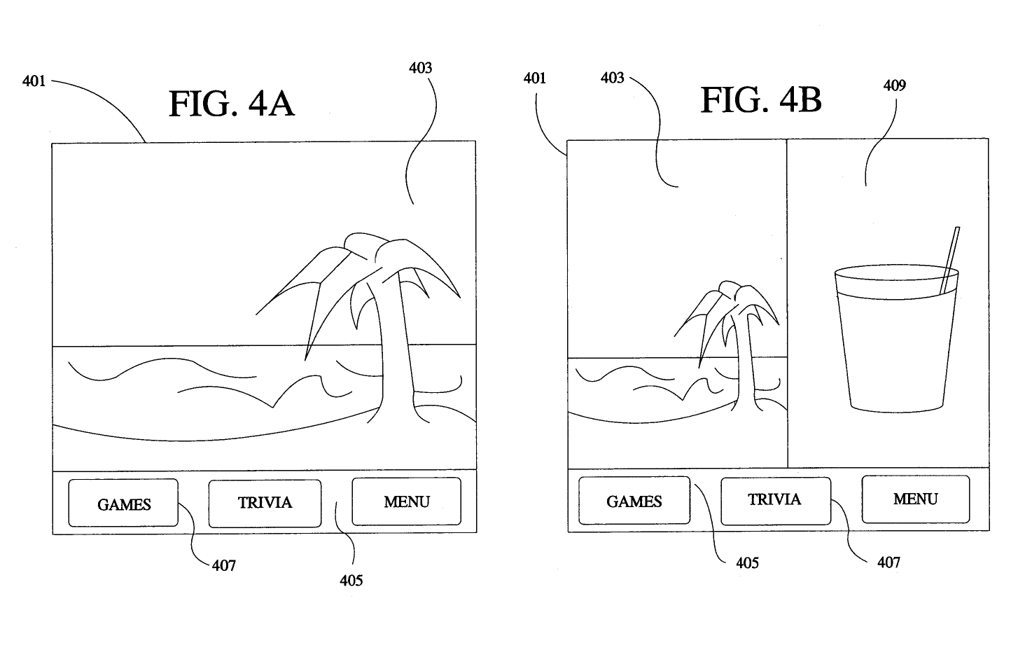

FIGS. 4A and 4B show exemplary advertising displays. In FIG. 4A, the screen 401 is primarily occupied by a single advertisement 403. This advertisement can vary by placement of the kiosk, time of day, and numerous other factors. In addition to the advertisement, a number of user selectable buttons 407 are displayed on a user input strip 405. Since this illustrative display is a touch-sensitive one (but need not be), the user only needs to push any one of the touch-sensitive buttons to select the desired option.

In this particular illustrative embodiment, three buttons are shown, corresponding to games, trivia and a menu. If this were deployed in a restaurant, for example, there could be a number of games associated with the kiosk, and selecting games could allow the user to play a game. Or, the kiosk could have one or more sets of trivia questions associated therewith, and the user could choose to answer trivia questions. The kiosk could even have rewards associated therewith, both to encourage use of the kiosk and to promote products. For example, if a certain number of trivia questions were successfully answered, or if a certain number of games were completed, the user could be provided with, for example, a coupon code for a free desert. Or a buy-one-get-one-free desert. Or any other suitable reward. Such rewards would drive kiosk use and may also serve to drive dessert sales and the like, with the buy-one-get-one options. A small printer could even be included with the kiosk that would print out a reward coupon, or a coupon could just be displayed on the kiosk screen.

Another option for a coupon delivery system would be an SMS message to a portable device. Since many of the advertisements shown will not be for products available on site, it may be desirable to provide the customers with incentive to purchase these products. If the customer inputs a phone number, for example, the system can cause a text message with a coupon code, or similar identifier, to be sent to the customer's phone. This has the added advantage of allowing the advertiser to track actual usage, since the code could be matched up against the kiosk system in general, or against a particular kiosk. This also provides additional data as to what advertisements are successful in what locations under what conditions, and can help in the future planning of what to show where and when. A further alternative would be to email a coupon or discount to a person for print-out at home, or to use any other suitable means of coupon/discount delivery.

Selecting menu could show a digital version of the restaurant's menu (or, for example, a list of salon services and prices). Even this menu could be tailored to time of day (e.g., lunch specials would only be shown at lunch, etc). The menu could only be shown on a portion of the screen, and, for example, the remaining portion of the screen could be used to show advertisements. Or, the screen could be even further subdivided, and one portion could show the menu, one portion could show a picture of a selected menu item, and one portion could show an advertisement. Any or all of these features may be implemented on a particular system. If users were encouraged to use the kiosk to view pictures of various menu selections, this could also ensure that they were viewing advertisements at the same time.

FIG. 4B shows an example of a split screen display, where one side 403 is showing an advertisement for which air time was purchased by an advertisement distributor. On the other side of the screen 409, an advertisement for a restaurant product is being shown. This allows the restaurant owner to constantly show advertisements for products, while not restricting the display of advertisements for which money is being paid

If the user were to select one of the options 407 in the user input section 405, the screen could be re-divided, or one or both of the advertisements could be overwritten by the display of the selected option.

Although several examples of menu buttons and divisions of displays have been provided, the screen can be appropriately divided or not divided in any fashion, and on-screen controls need not be provided. Additionally, if provided, any number or configuration of on-screen controls may be provided.

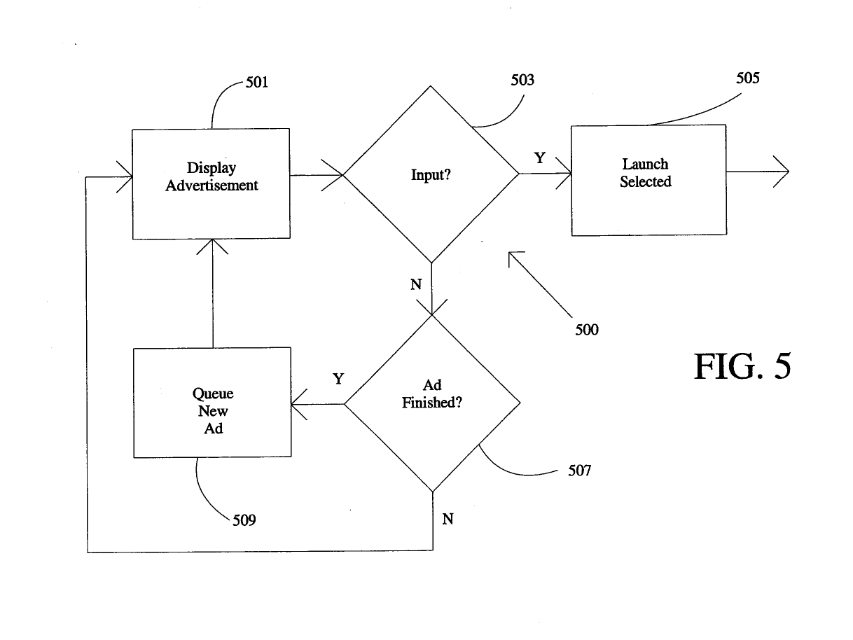

FIG. 5 shows an exemplary advertisement display process 500. This is just one illustrative embodiment showing one of many processes that may be used to display an advertisement on an advertising kiosk. The system first begins by displaying an advertisement 501. In this exemplary implementation, only a single advertisement is displayed, so this paradigm would most likely correspond to an exemplary display such as that shown in FIG. 4A, but it is not necessary that it does. After beginning advertisement display, the system checks to see if any input is present 503. This could be in the form of a touch-input, a button/joystick input, or any other input to the system. If input is present, then the system launches the selected aspect 505. If there is no input present, the system checks to see if the advertisement is finished 507. If the advertisement is not finished, the system continues to display the present advertisement. If, on the other hand, the advertisement is completed, a new advertisement is queued up 509, from, for example, a server feed or a kiosk internal memory, and that advertisement is then displayed 501. Numerous other methods of implementing advertisement display are also possible.

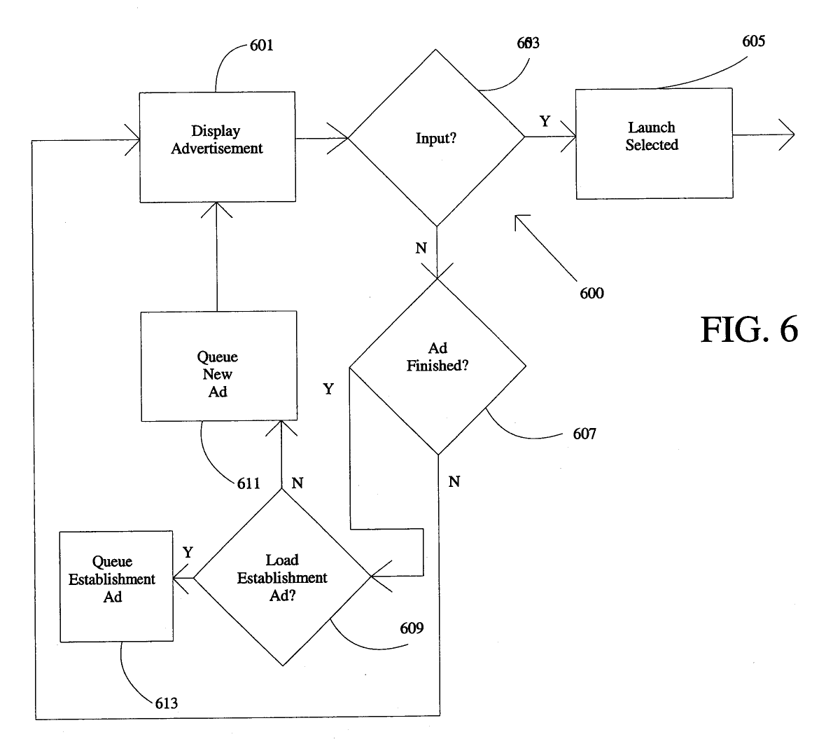

FIG. 6 shows a second exemplary advertisement display process 600. In this exemplary implementation, as before, the system starts out by beginning an advertisement 601. After the advertisement has begun, the system checks to see if there is any user input 603. Like before, if input is present, the selected aspect of the system is launched 605.

If input is not present, the system checks to see if the advertisement is completed 607. If the advertisement is still running, the system loops to 601 and repeats the above process.

If the advertisement is finished, the system checks to see if an establishment advertisement should be loaded 609. In this illustrative embodiment, a single advertisement is shown at a time. In exchange for the right to place the advertising kiosks within an establishment, however, the owner of the establishment is given a portion of the air time. Whether this amount is random or predetermined, the system checks before display of a new ad to see if it is time to display an owner's establishment ad. This ad could be for something as simple as a desert, or it could be a full blown commercial for the restaurant. In this manner, the owner benefits from the presence of the kiosk as well, as the customer can be reminded of particular products that customer may wish to purchase. In a beauty salon environment, the customer could be shown high margin hair care products or recommended services. In, for example, a dentist's office, the customer could be shown teeth whitening or other elective procedures.

All of this additional advertising can result in spot decisions by the customer to try something new, and result in additional revenue for the establishment owner. Additionally, since the owner is getting to use some of the air time, the kiosk distributor may not have to share advertising revenue with the owner.

If it is time for an establishment advertisement to be run, the establishment advertisement is queued up 613. Otherwise, the next advertisement ready for showing is queued 611. It is possible to in-line the establishment advertisements in a local server advertisement feed, so that they may be randomly selected by the system in place of “standard” advertisements as well.

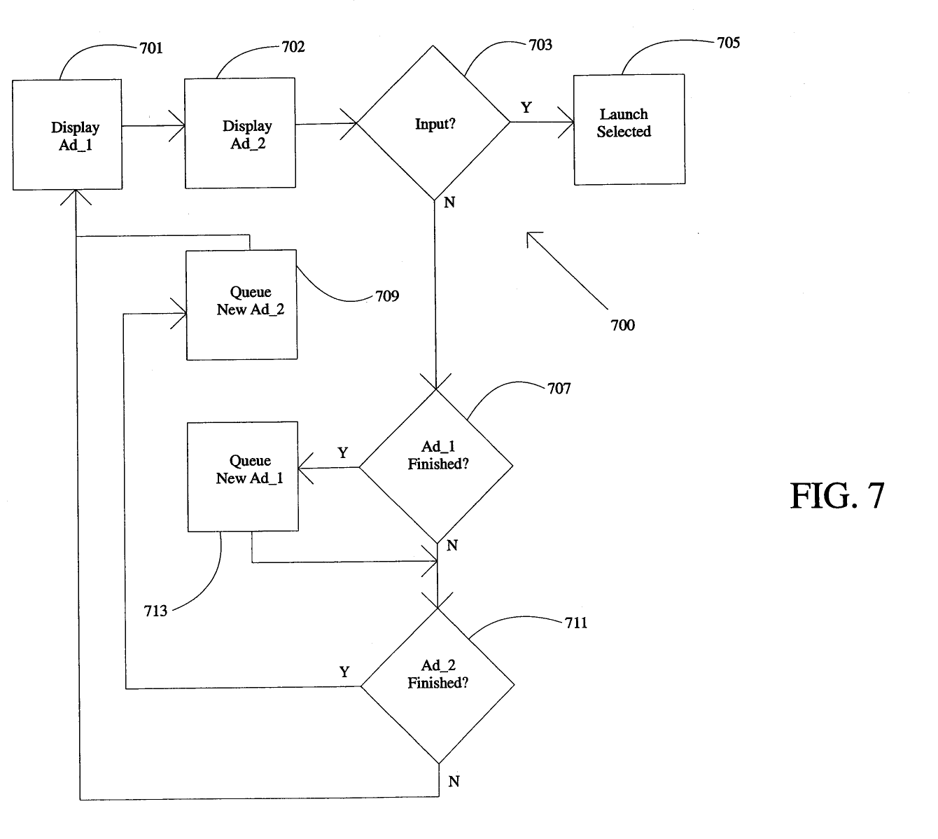

FIG. 7 shows a third exemplary advertisement display process 700. In this illustrative embodiment, dual advertisements are displayed. An exemplary display according to an advertising system such as this might be that seen in FIG. 4B, although the two need not necessarily correlate.

In this illustrative embodiment, the first and second ads are displayed 701, 702. After display of the advertisements, the system checks for input 703. If input is present, the selected feature is launched 705.

If input is not present, the system checks to see if the first advertisement is finished 707. If it is, a new first advertisement is queued 713. Whether or not the new first advertisement is queued, the system then checks to see if the second advertisement is finished 711. If that advertisement is finished, a new second advertisement is queued. 709. When the system has completed checking and any queuing for both advertisements, the system loops to continue display of the first and second advertisements.

Although this is one possible way that dual display of advertisements is possible, numerous appropriate display methodologies may be used.

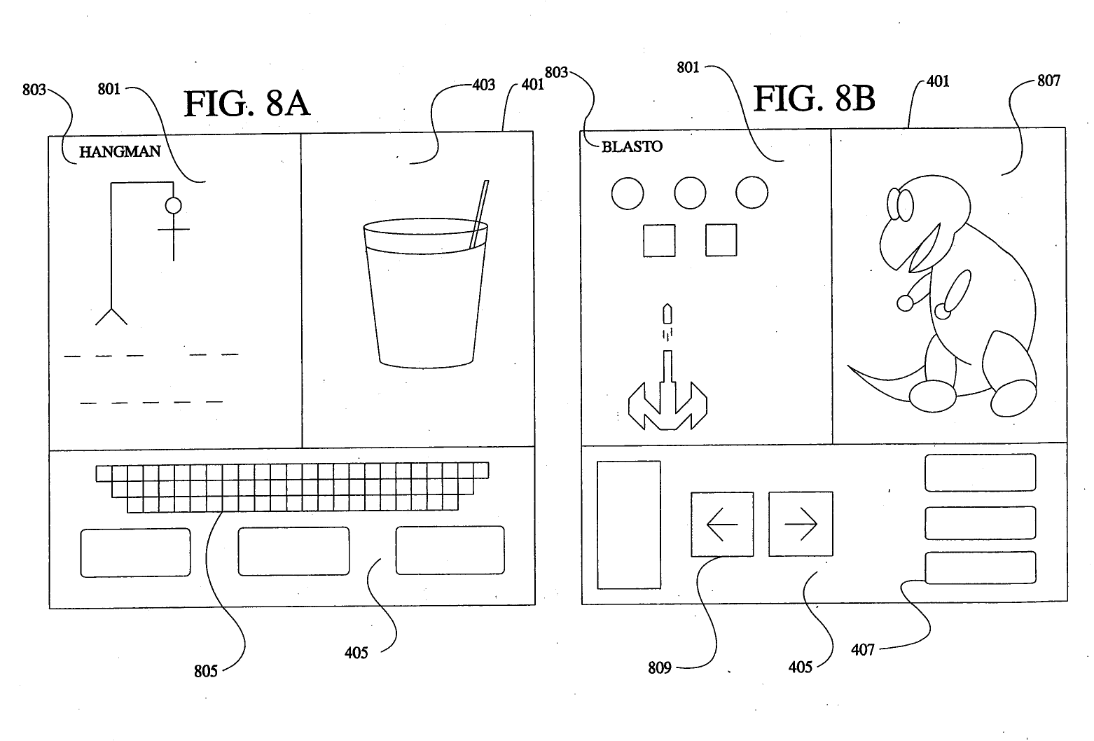

FIGS. 8A and 8B show exemplary game and advertisement displays. In both figures, the screen 401 is split between advertisement and game displays. Although the split is an even ratio in the drawings, any suitable arrangement and spacing may be provided.

In FIG. 8A, a game called “hangman” is being played. In this illustrative embodiment, the game title 803 is displayed, although such display is optional. Additionally, the game space 803 and the advertisement space 403 are similar, although such an arrangement may be changed. Since the game “hangman” requires alpha-numeric input, a keyboard 805 is digitally provided in the user input section 405. An external real keyboard could be additionally or alternatively provided.

In some cases, the kiosk and/or local server may decide, based at least in part on demographics determined from user interaction, what sort of advertisement 403 to display. For example, if the category for hangman was 1960s movie titles, the kiosk could reasonably “assume” that the player was an adult. Resultantly, it could elect to show commercials and advertisements that would be appealing to adults. It could even go a step further, and show advertisements for movies that would appeal to adults, since the category is 1960s movie titles. Or it could show advertisements for DVDs including 1960s movies. Since there is a measure of user interaction with the game, the system can take advantage of the interaction and dynamically and educatedly change the displayed advertisements.

In FIG. 8B, the game name 803 is “blasto” and the system has been told that typically only younger children play this game 801. Accordingly, an advertisement 807 for a toy dinosaur is being shown, which may appeal to the audience that typically plays “blasto”. Further, the controls for “blasto” are different for those of “hangman”, and a new digital set of controls 809 is appropriately provided. Since these digital controls occupy a portion of the screen that usually includes the selection buttons 407, the selection buttons have been rearranged and moved to a new location within the input section 405.

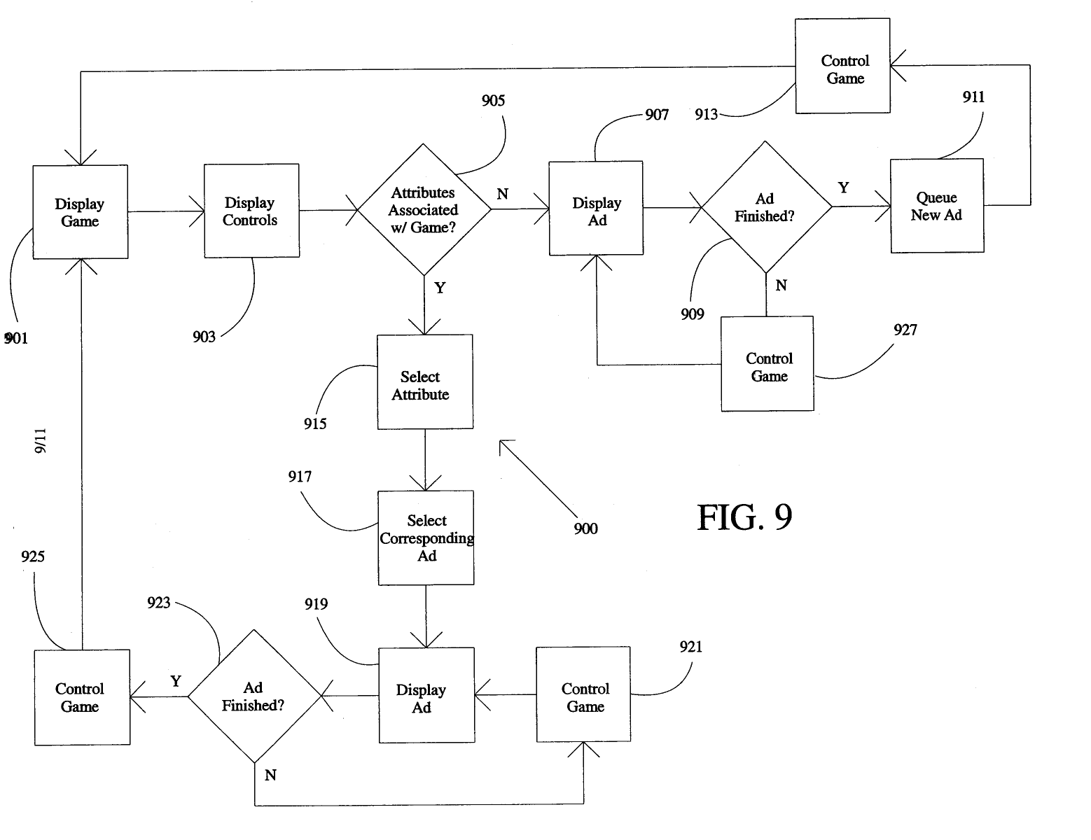

FIG. 9 shows an exemplary game and advertisement display process 900. In this illustrative embodiment, the system first displays a selected game 901 and the corresponding controls 903. Next, in this illustrative embodiment, the system checks to see if there are attributes associated with the game 905.

In this illustrative embodiment, attributes are parameters that can be used to designate a particular advertisement for display, or can be analyzed as part of the demographics used to determined which ads will be displayed. For example, the attributes could include, but are not limited to, age range of typical player, type of game, category of game, and any other number of conceivable factors upon which an advertising decision might be made.

Accordingly, the advertisements themselves are also tagged with corresponding attributes. In this illustrative embodiment, the game system selects one or more attributes after a determined fashion (e.g. cycling, random, etc.) 915 and then finds an advertisement with corresponding attributes 917. For example, if the game “blasto” has an expected player age range of 3-13, and the toy dinosaur ad has an expected interest age range attribute of 5-15, then it may be acceptable to show the advertisement, because of the overlap in ranges. If the expected interest age range of the advertisement were 12-17, then a better candidate advertisement might be selected that is more closely in line with the player age range of the game.

This is just one possible method of screening advertisements, and one possible analysis that can be performed within this exemplary screening process. Any number of suitable screening processes and analyses may be performed.

After a corresponding advertisement has been selected, the system displays the advertisement 919, checks to see if the advertisement is finished 923, and, regardless of the outcome of the test, effects game control 923, 921. If the advertisement is not finished, the system loops to continue displaying the advertisement, otherwise the system returns to game display 901.

If there are no attributes associated with the game, the system will select a next advertisement for display 907, based on a demographic analysis process, or randomly. Again, the system tests to see if the advertisement is finished 909, and, if so, queues a new ad 911. If the ad is not finished playing, the system continues display of the ad 907. In either event, game control is effected by the system 925, 913.

This is only one of many methods through which advertisement display and cotangent gameplay can be provided.

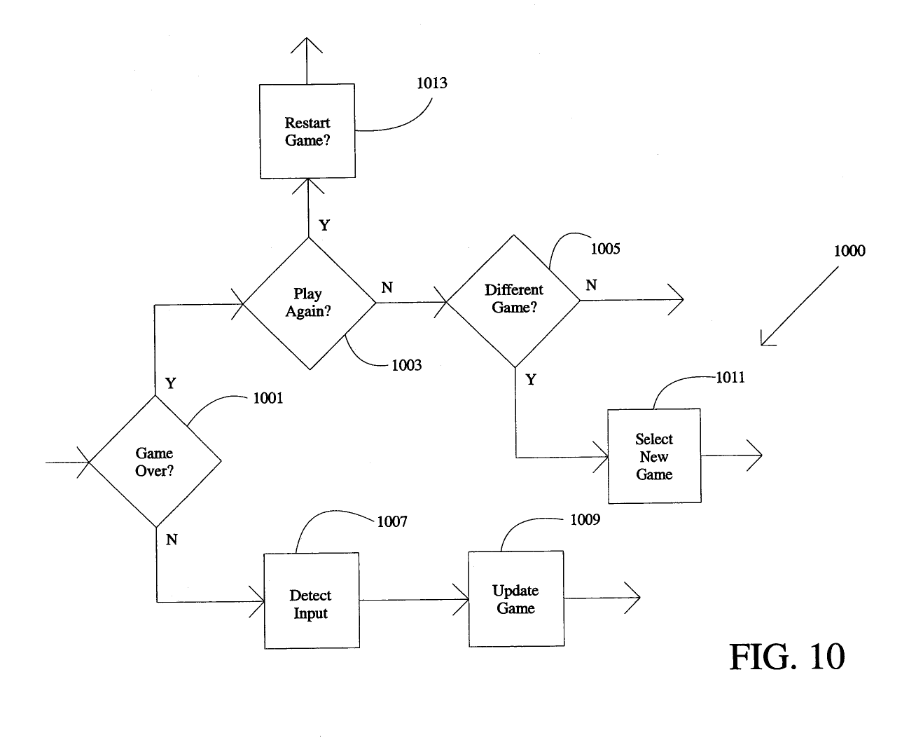

FIG. 10 shows an exemplary game control process 1000. In this illustrative embodiment, when the system is instructed to control a game, the system first checks to see if the game has ended 1001. If so, the system then checks to see if the player desires to play the game again 1003. If the player wishes to play again, the process returns to the flow of FIG. 9, and the game is restarted 1013 and displayed 901. If the player does not wish to play again, the system checks to see if a different game is desired 1005. If no different game is desired, the system may, for example, return to the display of an advertisement as shown by the process in FIG. 6. Otherwise, a new game may be selected 1011 and displayed 901.

If the game has not ended, the system detects a player input 1007 and updates the game accordingly 1009. This is merely one exemplary game control process out of many processes suitable for use with the illustrative embodiments.

In addition to making advertisement display decisions based on user input, such as the type of game being played or a menu/selection screen display, the system may also make advertising decisions based on external factors. Several non-exhaustive non-limiting examples include a local time or local weather conditions.

If the time is, for example, noon, then commercials for things to do after work can be shown to the lunch crowed likely present, or establishment advertisements pertaining to lunch may be displayed.

As another illustrative example, if it is snowing outside, it may be desirable to show advertisements for sunny getaways. Since a computer can determine the weather at that particular establishment with some degree of accuracy, using, for example, the internet and a local zip code, effective targeted advertising can be delivered on a variety of levels.

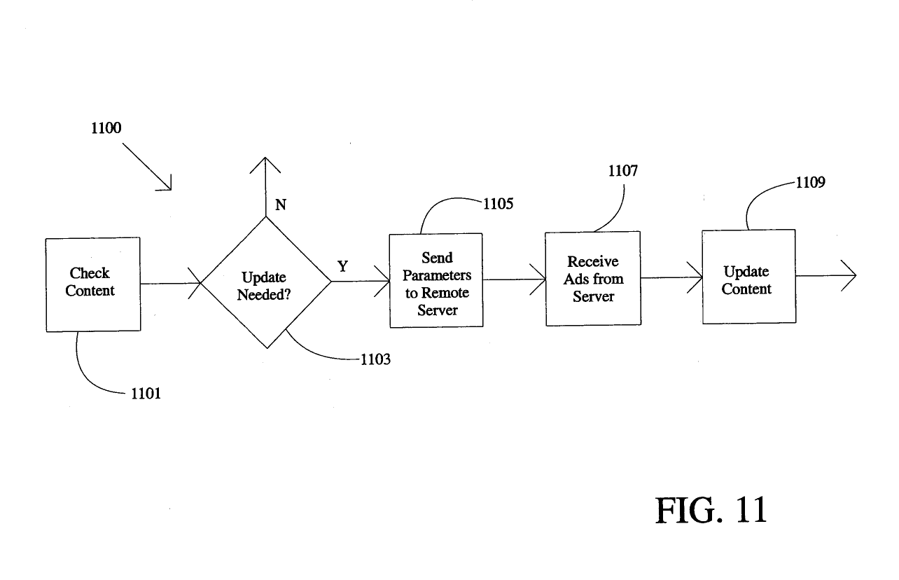

FIG. 11 shows an exemplary advertisement update process 1100. The local server and/or kiosk can check content stored thereon 1101 to see if an update is needed 1103, based on a variety of factors (e.g. time since last update, time of day, the ads have all been played, etc.). If an update is not needed, the system can return to the display of advertisements. If an update is needed, the local server, for example, may send a set of parameters to the remote server 1105. These parameters can include, but are not limited to, local time of day, location address, and any number of factors regarding the establishment clientele. The remote server can then select appropriate advertisements for delivery, send them, and the local server will receive the advertisements 1107. Finally, the content is then locally updated.

It is to be understood that the invention is not to be limited to the disclosed exemplary illustrative non-limiting implementations. On the contrary, the invention is intended to cover various modifications and equivalent arrangements included within the scope of the claims.

I claim:

1. An advertising delivery apparatus comprising:
a housing containing a display;
advertisement determination programmed logic circuitry to dynamically determine an advertisement to be displayed based at least in part on one or more demographic criteria;
advertisement display programmed logic circuitry to display, on the display, the determined advertisement to be displayed.

2. The advertising delivery apparatus of claim 1, further comprising:
one or more input controls to receive customer input, wherein the demographic criteria is determined based at least in part on received input.

3. The advertising delivery apparatus of claim 2, wherein the display is a touch sensitive display, and the one or more input controls include at least touch-enterable input controls accessible through interaction with the display.

4. The advertising delivery apparatus of claim 1, further comprising:
game display programmed logic circuitry to display a game on the display; and
game control programmed logic circuitry to control the game displayed on the display, based at least in part on customer input.

5. The advertising delivery apparatus of claim 4, wherein the game display programmed logic circuitry selects from a plurality of games for display, based at least in part on customer input, and wherein at least one of the games has information associated therewith, and wherein the demographic criteria is determined at least in part based on the information associated with the at least one game, when the at least one game is being displayed.

6. The advertising delivery apparatus of claim 1, wherein the advertisement determination programmed logic circuitry determines at least two advertisements to be displayed, at least one of the advertisements relating to an establishment in which the advertising delivery apparatus is deployed, and wherein the advertisement display programmed logic circuitry displays at least the advertisement relating to the establishment in which the advertising delivery apparatus is deployed, while at the same time displaying at least one additional advertisement.

7. The advertising delivery apparatus of claim 4, wherein game display programmed logic circuitry displays a game at the same time the advertisement display programmed logic circuitry is displaying at least one advertisement.

8. The advertising delivery apparatus of claim 1, wherein the advertisement determination programmed logic circuitry further determines whether or not to display an advertisement relating to an establishment in which the advertising delivery apparatus is deployed, based at least in part on predetermined criteria.

9. The advertising delivery apparatus of claim 1, further including coupon delivery programmed logic circuitry to deliver a coupon or discount to a customer.

10. The advertising delivery apparatus of claim 9, wherein the coupon is delivered on the display.

11. The advertising delivery apparatus of claim 9, wherein the coupon is delivered to a portable device via an SMS message.

12. The advertising delivery apparatus of claim 2, further including menu display programmed logic circuitry to display a menu including at least goods or services offered by an establishment in which the advertising delivery apparatus is deployed.

13. The advertising delivery apparatus of claim 12, wherein at least one item on the menu is customer selectable, and wherein selection of the item causes menu item display programmed logic circuitry to display information relating to the menu item on the display.

14. A method for targeted advertisement delivery on an advertisement delivery kiosk, including at least a display, comprising:
dynamically determining one or more advertisements to be displayed on the display, based at least in part on demographic information; and
displaying the one or more dynamically determined advertisements on the display.

15. The method of claim 14, wherein the advertisement delivery kiosk further includes at least one input control to receive input, the method further comprising:
receiving input, wherein the demographic information is determined based at least in part on the received input.

16. The method of claim 15, further including:
displaying at least one game controllable by the at least one input control, wherein the demographic information is determined based at least in part on the displayed at least one game.

17. An advertisement delivery system comprising:
at least one advertising delivery kiosk;
at least one local server to serve advertisements to at least one advertising delivery kiosk;
at least one remote server to serve advertisements to at least one local server;
wherein at least one of the local server or the advertising delivery kiosk determines a next advertisement to be displayed on the advertising delivery kiosk, based at least in part on demographic criteria; and
wherein the remote server provides advertisement updates to at least one of the local servers.

18. The advertisement delivery system of claim 17, wherein at least one local server transmits information about the establishment where the transmitting server is located to the remote server.
